(19) United States
(12) Patent Application Publication
(10) Pub. No.: US 2007/0027974 A1
(43) Pub. Date: Feb. 1, 2007

(54) Online service monitoring

(75) Inventors: Juhan Lee, Issaquah, WA (US); John Dunagan, Bellevue, WA (US); Alastair Wolman, Seattle, WA (US); Chad Verbowski, Redmond, WA (US); Stephen Lovett, Sunnyvale, CA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/194,891

(22) Filed: Aug. 1, 2005

(51) Int. Cl. G06F 15/173

(52) U.S. Cl. 709/223

(57) ABSTRACT

A status notification method and facility is provided for use with a service chain processing a request for a service. The service chain can include multiple computer nodes, and the method includes dynamically creating the service chain for processing the request, and guaranteeing agreement, on at least two of the nodes of the service chain, about the status of the processing of the request. The method can also include saving detailed operational data logs in response to determining that a failure in processing the request has occurred. When a given node in the service chain determines that failure has occurred, agreement about the failure can be propagated throughout the service chain. Also, conditional logging of detailed operational data can minimize the amount of operational data transmitted over a network and saved to a data repository.

### BACKGROUND OF INVENTION

Online service providers offer a variety of services to end-users including email services, instant messaging, online shopping, news, and games, to name but a few. Although varied in their content, such online services can all be provided by a set of servers operating as a system and forming a service chain.

For example, upon initiating a login to an email account service, an end-user's request may be handled by a login server front-end and a login server back-end, which constitutes a first service chain. Upon successful login, a second service chain comprising of an email server and an address book server can provide the end-user with access to their email messages. In this way, online services can be provided to end-users via service chains that can comprise multiple servers operating as a system. Furthermore, components such as network load balancers, can dynamically create a service chain of servers by directing a service request to redundant servers providing the same function.

To support scalability and reliability, the same service chain may not necessarily support multiple user service requests over time or for different users. In particular, each of the servers that constitute a given service chain may be drawn from a pool of available servers (e.g., using network load balancers) and form the service chain that responds to a given request a service.

Monitoring the performance and failure of such services is currently achieved via a number of limited approaches. One technique involves using simulated transactions and monitoring datacenter servers so as to deduce service quality. Another technique involves collecting various performance statistics from datacenter elements (e.g., servers and networks) to deduce the performance characteristics of the services. Yet another approach uses third party vendors to initiate synthetic user transactions. Lastly, to better approximate the end-user perspective, online service providers can also collect exception data from end-user software, or purchase end-user statistics gathered by third party vendors.

### SUMMARY OF INVENTION

Current methodologies to measure the general availability and performance of services are indirect and fail to provide insight into the performance and availability of nodes (e.g., servers) that constitute a service chain providing an online service.

Various embodiments of the invention can determine how an end-user experiences the delivery and performance of online services. Nodes of a service chain can be instrumented so as to provide request/response tracking and distributed agreement on nodes in the service chain regarding the status (e.g., success and/or failure) of transactions. Various embodiments of the invention provide the ability to record the service chain created to respond to a given request for an online service.

Some embodiments of the invention can enable the association of events that occurred on nodes along the service chain, which can facilitate the identification of anomalies (e.g., possible failures) and can allow for the determination of the ordering of events that occurred on the nodes. Such information can facilitate root cause analysis of failures, thereby allowing for the determination of the specific node(s) on which failures occurred (rather than just an indication that the overall service chain failed).

A method is also provided to enable the logging of one set of operational data when the transaction was successful, and a different set of operational data when the transaction failed. The method allows for conditional logging by nodes in a service chain, where detailed logs may be saved only for transactions that fail. Because the success or failure of the transaction may not be known until the transaction has passed through the entire service chain, such distributed conditional logging may use a distributed agreement mechanism (e.g., status notification).

Furthermore, an integrated system is provided that can combine distributed agreement between nodes in a service chain with conditional logging into an end-to-end service monitoring solution that can supply logging and failure detection. The conditional logging can use status notification, combined with timeouts, to control logging and/or failure detection. The logging facility can incorporate implicit failures such as absence of communication, explicit failures such as improper configuration, and latency alerts where end-to-end or node response times have degraded beyond a threshold.

### BRIEF DESCRIPTION OF DRAWINGS

In the drawings, each identical or nearly identical component that is illustrated in various figures is represented by a like numeral. For purposes of clarity, not every component may be labeled in every drawing. In the drawings:

FIG. 1 is a block diagram of a prior art system where online services are provided to an end-user;

FIG. 2 is a block diagram of a prior art network within which a service chain may be established;

FIG. 3 is a block diagram of a service chain of nodes in a network that are established to process a request for a service;

FIG. 4 is a block diagram of a service chain where status notification facilities are present on the service chain nodes in accordance with one embodiment of the invention;

FIG. 5 is a block diagram of a service chain where data may be received, collected, processed, and/or stored by one or more data collection components in accordance with one embodiment of the invention;

FIG. 6a is a block diagram of a service chain where failure alerts may be collected by an event log collector in accordance with one embodiment of the invention;

FIG. 6b is a block diagram of a service chain where operational data may be stored in one or more data repositories in accordance with one embodiment of the invention;

FIG. 7 is a block diagram of a service chain having status notification facilities on all nodes in accordance with one embodiment of the invention;

FIG. 8 is a block diagram of a service chain having status notification facilities on some nodes in accordance with one embodiment of the invention;

FIG. 9 is flow diagram illustrating a method which can be performed by an initiator node of a service chain for monitoring and reporting the status of a request in accordance with one embodiment of the invention;

FIG. 10 is flow diagram illustrating a method which can be performed by a middle node of a service chain for monitoring and reporting the status of a request in accordance with one embodiment of the invention;

FIG. 11 is flow diagram illustrating a method which can be performed by an end node of a service chain for monitoring and reporting the status of a request in accordance with one embodiment of the invention;

FIG. 12 is a block diagram of a service chain having status notification facilities and experiencing a first example of a failure; and

FIG. 13 is a block diagram of a service chain having status notification facilities and experiencing a second example of a failure.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Online services require the successful functioning of many different systems along a service chain (e.g. datacenter facilities, the Internet, and end-user software) that enables the processing of a user's request for a service.

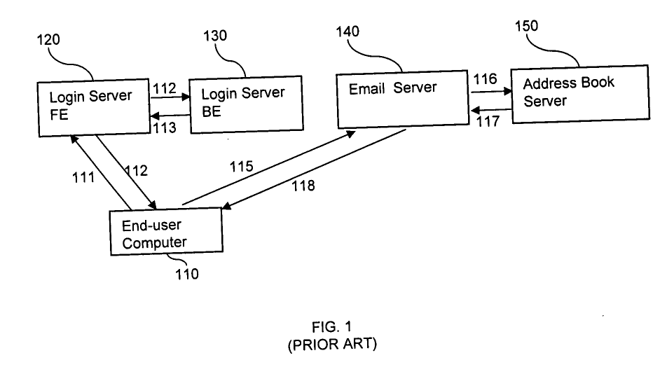

FIG. 1 illustrates a prior art system where online services are provided to an end-user computer 110 (i.e., client) via multiple servers fulfilling specific functions. In this example, an end-user computer 110 sends a login request 111, including a username and password, so as to access an email account service maintained by an online service provider. The request is first processed by a login server frontend 120, which is responsible for providing a user interface to the end-user. The login server frontend 120 passes along a request 112 to a login server backend 130, which may comprise a database system that retrieves user account information. Upon determining whether the login information supplied by the end-user computer 110 is correct, the login server backend 130 sends a response 113 to the login server frontend 120. The login server frontend 120 then sends a response 112 to the end-user computer 110, either authorizing or denying access to the email account service.

During this sequence of interactions, a service chain is established to reply to a user's request to access their email account service. In this case, the service chain includes the end-user computer 110, the login frontend server 120 and the login backend server 130. Also, the specific severs in this service chain may be determined dynamically during the processing of the user's request, possibly via the use of network load balancers that can redistribute requests based on the workload on servers. In this way, the specific servers that will constitute the service chain may not be known prior to the processing of a request sent by an end-user.

Upon receiving authorization to access the email account service, the end-user (via the end-user computer 110) might send a request 115 to an email server 140 to compose an email message by accessing the end-user's address book. In this example, the email server 140 then sends a request 116 to an address book server 150 that retrieves the end-user's address book data and sends a response 117 to the email server 140. The email server 140 then sends a response 118 comprising the address book data to the end-user computer 110, thereby enabling the end-user to select appropriate entries in their address book.

As in the processing of the login request, a service chain including the end-user computer 110, the email server 140, and the address book server 150 is established to process the end-user's request. Also, as in the login request case, the servers in the service chain that process the end-user's request may be determined dynamically during the processing of the user's request, and hence may not be known upon the issuance of the request by the end-user.

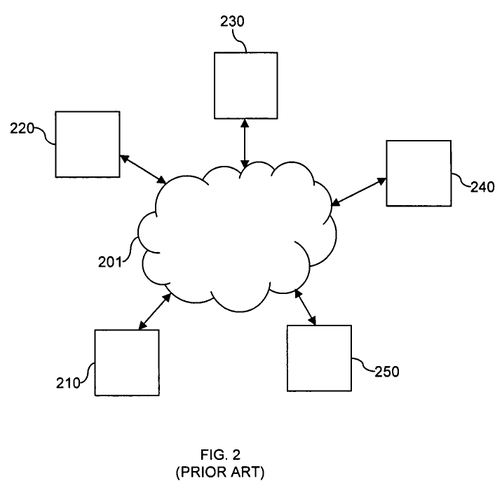

FIG. 2 illustrates a network within which service chains may be established. The illustrative network includes computers 210, 220, 230, 240, and 250 communicating with one another over a network 201, represented by a cloud. Network 201 may include many components, such as routers, gateways, hubs, network load balancers, etc. and can allow the computers 210-250 to communicate via wired and/or wireless connections. When interacting with one another over the network 201, one or more of the computers 210-250 may act as clients, servers, or peers with respect to other computers. Therefore, various embodiments of the invention may be practiced on clients, servers, peers or combinations thereof, even though specific examples contained herein do not refer to all of these types of computers. As such, so as to not limit the types of computers on which embodiments of the invention may be practiced, computers 210-250 are referred to as computer nodes (or nodes), irrespective of their role as clients, servers, or peers.

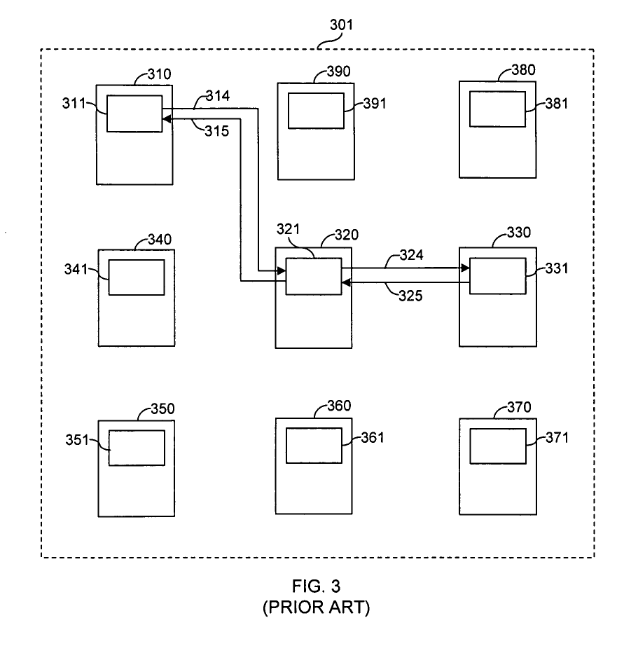

FIG. 3 illustrates a service chain of nodes in a network 301 that are established to process a request for an online service. Network 301 can enable communication between any of the nodes 310, 320, 330, 340, 350, 360, 370, 380 and 390 (referred to as 310-390). Network 301 may include components, such as routers, gateways, hubs, network load balancers, etc. and allows the nodes 310-390 to communicate via wired and/or wireless connections. Applications 311, 321, 331, 341, 351, 361, 371, 381, and 391 (referred to as 311-391) reside on nodes 310-390, respectively, and can perform specific functions associated with the processing of the request for the online service. Furthermore, some the nodes 310-390 may be redundant, meaning that the same application may reside on these redundant nodes, which allows for the service chain to be established using a number of different nodes, and routed dynamically, possibly depending on the workloads on each of the nodes 310-390.

In the example of FIG. 3, node 310 acts as a client and the application 311 on node 310 issues a request 314 for an online service. The request may be routed by components (not shown) in network 301 and directed to node 320. Node 320 acts as a first server, and the application 321 on node 320 processes the request, and as a result issues another request 324 that may be needed to issue a response to the request 314. The network 301 routes the request 324 to a node 330, on which an application 331 processes the request 324 and issues a response 325 to node 320. Application 321 on node 320 then processes the response 325 and issues a response 315 to node 310. Application 311 receives the response 315, thereby completing the service chain for the desired online service.

Applicants have appreciated that it is difficult to determine the performance and availability of online services as they are delivered to end-users. For example, currently, online service providers lack access to real-time end-to-end performance of services and the identity (and performance) of individual servers that constitute the service chain. Online service providers also do not readily know how often their services fail, nor can they readily ascertain the causes of failures in enough detail to prevent them from reoccurring. These challenges can impede the ability of operations and product development staffs to maintain day-to-day service operations and to plan for longer term management tasks and feature releases.

In various embodiments of the invention, nodes along a service chain can be instrumented to provide request/response tracking, and/or agreement on the failure and/or success of user-initiated transactions. Instrumentation of the nodes along a service chain may also provide an indication of the nodes that constitute the service chain for a specific request. Furthermore, failure alerts and/or logging can be generated for implicit failures (e.g., network failures, non-responsive nodes), explicit failures (e.g., application errors), and performance metrics (e.g., end-to-end and individual node latencies). The alerts and/or logging can be generated and fed into existing management infrastructures.

In various embodiments of the invention, nodes of a network providing an online service may include status notification facilities to guarantee agreement, between those nodes of a service chain, about failures in handling a service request. Furthermore, in some embodiments, successes in handling a service request may not necessarily be guaranteed to be agreed upon by all the nodes of a service chain having status notification facilities. For any successes that may be mistakenly determined to be failures (e.g., referred to as false-positives) by one or more of these nodes of a service chain, post-processing of logged data may be used to resolve the disagreement.

In accordance with one embodiment, a method is provided for use with a service chain processing a request for a service, wherein the service chain comprises a plurality of nodes processing the request. The method comprises guaranteeing agreement, on at least two of the plurality of nodes, about a status (e.g., failure and/or success) of the processing of the request. In some embodiments, the method can also comprise dynamically creating the service chain of nodes for processing the service request.

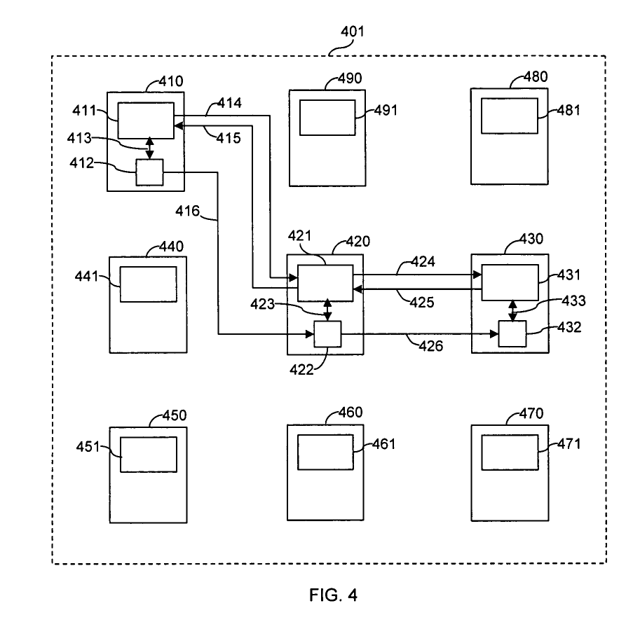

FIG. 4 shows an embodiment wherein status notification facilities are present on nodes in a service chain, where the status notification facilities can guarantee agreement regarding a status of the processing of the request on nodes in the service chain.

In the embodiment of FIG. 4, a service chain of nodes in a network 401 are established to process a request for an online service. Network 401 can enable communication between any of the nodes 410, 420, 430, 440, 450, 460, 470, 480, and 490 (referred to as 410-490). Nodes 410-490 may act as clients, servers, peers or combinations thereof, and can perform the processing of the request. Network 401 may include components, such as routers, gateways, hubs, network load balancers, etc. and allows the computers 410-490 to communicate via wired and/or wireless connections. Applications 411, 421, 431, 441, 451, 461, 471, 481, and 491 (referred to as 411-491) reside on nodes 410-490, respectively, and can perform specific functions associated with the processing of the request for the online service. Furthermore, some of the nodes 410-490 may be redundant, meaning that the same application may reside on these redundant nodes, which allows for the service chain to be established using a number of different nodes, and routed dynamically, possibly depending on the workloads on each of the nodes 410-490.

To guarantee agreement regarding a status of the processing of the request on the nodes 410, 420, and 430, these nodes may include status notification facilities 412, 422, and 432. The status of the processing of the request may include an indication that the request for the service has been successfully responded to, or an indication that a failure has occurred in responding to the request for the service. Status notification facilities 412, 422, and 432 can attempt to ensure agreement about the status of the request via notification transmissions 416 and 426 between the nodes in the service chain. The status notification facilities can be implemented using application programming interfaces that enable communication (represented by arrows 413, 423, and 433) with applications 411, 421, and 431, but the invention is not limited in this respect, and the status notification facilities may be implemented in any other manner.

Optionally, on one or more nodes, the status notification facilities may be integrated into the applications processing the service request. For example, if node 410 was a client being used by an end-user utilizing an application (e.g., a web browser, an instant messaging application, etc.) to issue a request for an online service, the status notification facility for this node may be integrated into the application. Optionally, the status notification facility could be a plug-in which plugs into an existing application (e.g., web-browser) not having an integrated status notification facility, or having an out-dated version of a status notification facility.

In the illustration of FIG. 4, node 410 acts as a client and application 411 issues a request 414 for the service. The request may be routed by components (not shown) in network 401 and directed to node 420. Node 420 acts as a first server, and application 421 processes the request, and as a result, issues another request 424 that may be needed to issue a response to the request 414. The network 401 routes the request 424 to a node 430, on which an application 431 processes the request 424 and issues a response 425 to node 420. Application 421 on node 420 then processes the response 425 and issues a response 415 to node 410. Application 411 receives the response 415, thereby completing the service chain for the online service.

Upon receiving a usable response 415, the application 411 may communicate 413 with the status notification facility 412 providing direction to issue a status notification regarding the successful completion of the request for the service. The status notification facility 412 may then issue a status notification 416 to the status notification facility 422 on node 420 in the service chain. Upon receiving the status notification, status notification facility 422 may in turn relay a status notification 426 to status notification facility 432 on node 430 in the service chain. In this way, all nodes in the service chain may learn of the successful completion (and/or failure) of the service request. Furthermore, only those nodes 410, 420, and 430 that constituted the service chain need to be informed of the status of the request, and other nodes in the network 401 need not be informed, thereby minimizing processing and network overhead.

Although the status notification facilities attempt to guarantee agreement, across nodes in the service chain, regarding successes and/or failures in processing a request for a service, in some instances, some nodes may conclude that a failure occurred, even though other nodes conclude that the processing of the request was a success. For example, if node 430 were to lose connectively to node 420 after having issued response 425, then node 430 would never receive the status notification 426 and may conclude that the processing failed. In cases like these, where one or more nodes conclude that a failure occurred but other nodes conclude that the processing was a success, logged data (e.g., saved by nodes in the service chain) may be analyzed during post-processing to resolve the disagreement.

Although the illustration of FIG. 4 shows three nodes in a service chain, any number of nodes may be present in service chains that process a request for a service. Furthermore, which specific nodes in a network process a request may be determined dynamically during the processing of the request, and may not be known prior to the submission of the request for the service.

In accordance with one embodiment, failures associated with the processing of a request may be reported. The failures may be reported as alerts that may be sent to a service operations center (i.e., site operations center) that may be charged with the duty of managing and maintaining the proper functioning of the online service, but may also, in addition to or instead of, be reported to any other entity, as the invention is not limited in this respect.

In accordance with one embodiment, operational data related to the processing of the request may be saved by one or more nodes in a service chain processing a request.

In accordance with another embodiment, conditional logging may be provided, where a first type of operational data may be saved by one or more nodes of a service chain upon determination that a failure has occurred in the service chain processing a request, and a second type of operational data may be saved upon determination of success. For example, the operational data saved for failures may be more detailed and include more information than operational data saved for successes. By conditionally saving detailed data upon failures, and not necessarily saving the same detailed data for successful transactions, the overhead for collecting detailed operational data logs may be reduced.

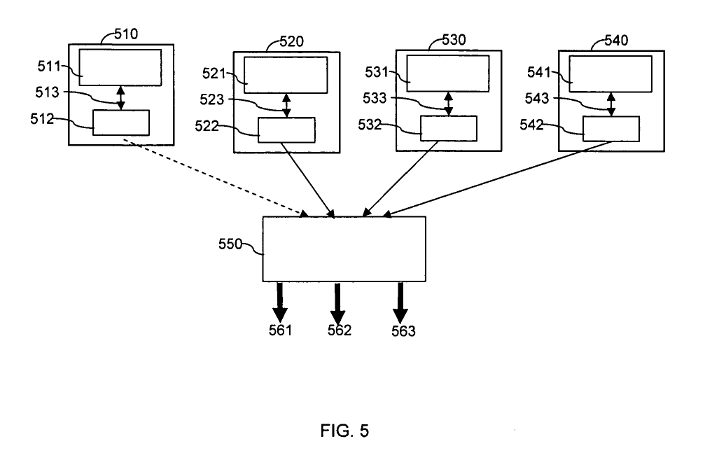

FIG. 5 illustrates a service chain where operational data, failure alerts, and/or any other data may be received, collected, processed, and/or stored by one or more data collection components. In the example of FIG. 5, nodes 510, 520, 530, and 540 (referred to as nodes 510-540) constitute nodes in a service chain processing a request for an online service. Although, requests and responses between nodes 510-540 are not shown in the figure, it should be understood that node 510 can send a request to node 520 and receive a response from node 520. Similarly, node 520 can send a request to node 530 and receive a response from node 530. Also, node 530 can send a request to node 540 and receive a response from node 540. The nodes 510-540 comprise a service chain which may be created dynamically (e.g., using one or more network load balancers) upon the initiation of a request for an online service.

Applications 511, 521, 531, and 541 (referred to as 511-541) may handle and process requests and responses regarding the processing of the request for the service. The applications 511-541 may, respectively, interface (indicated by arrows 513, 523, 533, and 543) with status notification facilities 512, 522, 532, and 542 (referred to as 512-542). The status notification facilities 512-542 can issue status notifications to one or more nodes in the service chain, where the status notification may include an indication of the success or failure in processing the request for the online service. Status notification facilities 512-542 can be integrated into the applications 511-541, or implemented in other ways, as the invention is not limited in this respect.

In this example, node 510 may be a client being used by an end-user utilizing the application 511 (e.g., a web browser, an instant messaging application, etc.) to issue a request for an online service, but it should be noted that node 510 is not limited to being a client used by an end-user. Rather, node 510 may be a first node having a status notification facility in a service chain that includes nodes other than those shown in the illustration of FIG. 5. For example, a node without a status notification facility may send a request to node 510. In such a scenario, a status notification of success or failure is indicative of whether the request was successfully handled by the nodes with status notification facilities, and therefore may not be an indication of whether the node issuing the request to node 510 received a response.

Status notification facilities 512-542 can generate operational data, failure alerts, and/or any other data that may be sent to (and/or collected by) one or more data collection components 550. Although not shown in the example of FIG. 5, there may also exist intermediate logging files or components where failure alerts, operational data, and/or any other data, may be stored prior to being sent (or collected by) the one or more data collection components 550. The one or more data collection components 550 may use the data relating to the processing of service requests to generate failure alerts 561, capacity planning reports 562, and/or quality of service reports 563.

In cases where node 510 is a client being used by an end-user accessing a service, the status notification facility 512 may not generate operational data, failure alerts, and/or any other data that may be sent to (and/or collected by) the one or more data collection components 550. This ability to disable the generation and transmission of such data (as indicated by a dashed arrow in FIG. 5) may be used to offer a user the choice to enable or disable the data reporting feature.

Failure alerts may be generated by one or more nodes 510-540 in the service chain and may be sent (or collected by) data collection components 550. The data collection components 550 can process the alerts and direct them to a service operations center (not shown), and/or to any other entity, as the invention is not limited in this respect. Optionally, failure alerts due to the same node may be aggregated into a single combined alert so that a burst of failures does not lead to a large number of related alerts attributed to the same cause.

Failure alerts may include a unique identifier (e.g., an ID uniquely identifying the processing of the request for the online service), an indication of the service being requested, information identifying the nodes known to be involved in the request (i.e., nodes in the service chain), the reason for failure (e.g., timeout or explicit failure with error message), and other information, as the invention is not limited in this respect.

Operational data relating to the processing of the service request on the service chain may also be sent (or collected by) data collection components 550. Operational data may be generated by the status notification facilities 512-542 present on the nodes 510-540 in the service chain. Every time a request completes on a node having a status notification facility, operational data may be sent (or collected by) data collection components 550. Optionally, sampling may be used to keep the data rate manageable.

Operational data (and operational data logs) may include a unique identifier (e.g., an ID uniquely identifying the processing of the request for the online service), the node at which the operational data was recorded, a sampling rate, an identification of the upstream requester node (i.e., the node that sent the request), an identification of the downstream receiver node (i.e., the node that the current node sent a request to), a latency from request initiation to reply return at this node, time of request completion, a status summary (e.g., success or failure), a reason for a failure (e.g., timeout or explicit cause), an error message (if an explicit error occurred), and other information, as the invention is not limited in this respect. Furthermore, in the case where conditional logging is enabled, the operational data saved for failures may be different than the operational data saved for successes. For example, the operational data saved for failures may be more detailed and include more information than the operational data saved for successes.

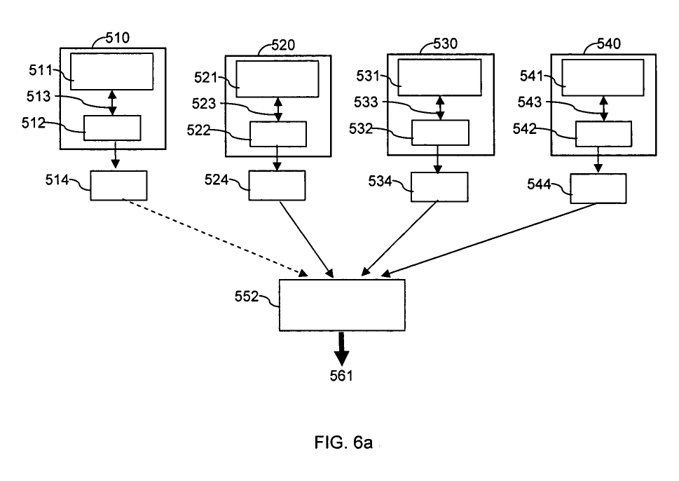

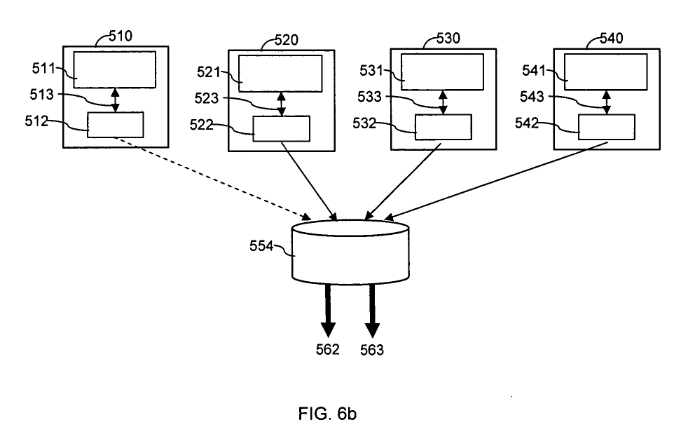

FIG. 6a shows an event log collector for collecting alerts in a service chain having status notification facilities. As in FIG. 5, the nodes 510-540 in the service chain include status notification facilities 512-532 that can generate failure alerts upon a failure in processing a service request. In the system of FIG. 6a, failure alerts may be saved in one or more event logs 514, 524, 534, and 544 (referred to as 514-544). The event logs may reside on the specific nodes that generated them, or may reside on any other node in the network.

The entries in the event logs 514-544 may be collected by one or more event log collectors 552. The one or more event log collectors 552 may perform aggregation and/or filtering of the collected failure alerts, and may send failure alerts 561 to one or more specified entities. For example, the failure alerts 561 may be sent to a first and/or second tier of a service operations center.

FIG. 6b shows a data repository for storing operational data for a service chain having status notification facilities. As previously stated in connection with FIG. 5, status notification facilities 512-542 may generate operational data relating to the processing of a service request. The operational data may be sent to one or more centralized data repositories 554, which can be used to group, analyze and present the data in multiple forms, including capacity planning reports 562, quality of service reports 563, and other types of reports, as the invention is not limited in this respect. The one or more data repositories 554 may comprise an operational database, which may in turn store the data in a data warehouse, but any other type of data repository may be used.

The status notification facilities 512-542 may be configurable to write to a network pipe, implementing tail-drop and alerting via an event log if the pipe is full. The network pipe may send data to the one or more data repositories 554.

The status notification facilities 512-542 may also be configurable to write to a local disk, implementing tail-drop and alerting via an event log if the pipe is full. In this case, the local disk works as a buffer for one or more collection agents (not shown), which can work asynchronously and perform data aggregation. The one or more collection agents can collect the operational data which can then be sent to the one or more data repositories 554.

In one embodiment, status notification facilities on two or more nodes in a service chain may guarantee agreement about a status of the processing of the request. The status can include an indication of the failure or success in processing a request to access a service.

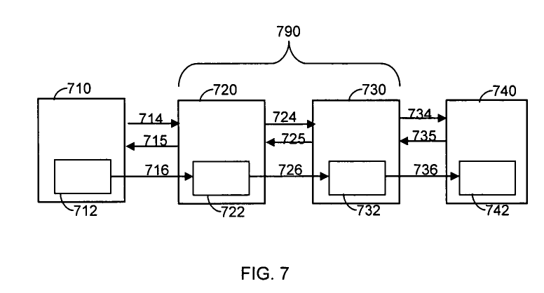

FIG. 7 illustrates a service chain having status notification facilities on an initiator node 710 (a first node in a service chain having status notification facilities), middle nodes 790 (comprising nodes 720 and 730), and an end node 740 (a last node in a service chain having status notification facilities). Agreement about the status of the processing of the request can be accomplished by communication between status notification facilities 712, 722, 732, and 742 (referred to as 712-742). As previously noted, the nodes in a service chain may be determined dynamically (e.g., via one or more network load balancers), and the use of status notification facilities may attempt to ensure agreement about the status of the request between nodes in the service chain.

In this illustration, node 710 sends a request 714 to node 720, node 720 sends a request 724 to node 730, and node 730 sends a request 734 to node 740. Then node 740 sends a response 735 back to node 730, node 730 sends a response 725 back to node 720, and node 720 sends a response 715 back to node 710. Upon receiving the response, the initiator node 710 that initiated the request may issue a status notification 716 (e.g., indicating success or failure) via the status notification facility 712. The status notification 716 may be received by status notification facility 722 on node 720, and the status notification facility 722 may then send a status notification 726 to the status notification facility 732 on node 730. Then status notification facility 732 may then send a status notification 736 to the status notification facility 742 on node 740.

In the illustration of FIG. 7 (and the illustrations that follow), only some elements are shown for the sake of clarity, namely status notification facilities and nodes, but this does not preclude the incorporation of other elements, including applications, event logs, data repositories, and/or any other elements. Furthermore, processes and interactions between elements described in previously mentioned embodiments, may be incorporated. For example, failure alerts, operational data logging, and/or other operations may be included.

In some embodiments, status notification facilities are present on only some nodes of a service chain, and can attempt to guarantee agreement about a status of the processing of the request. In this way, status notification facilities may be implemented incrementally on nodes constituting a network, and need not be present on all nodes in a service chain.

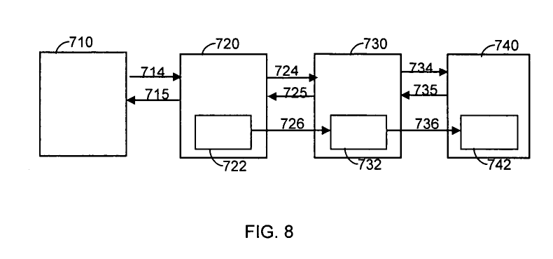

FIG. 8 shows an illustration of such an embodiment, wherein node 710 does not include a status notification facility and as such does not send a status notification to node 720 about whether a successful response 715 was received. Rather, in this example, node 720 is the initiator node, namely the first node in the service chain that includes a status notification facility. As such, status notification 726 sent by status notification facility 722, to status notification facility 732, may not include information about whether node 710 successfully received a response to its request for the service provided by the service chain.

In one embodiment, a method is provided which can be performed by an initiator node of a service chain for monitoring and reporting the status of a request.

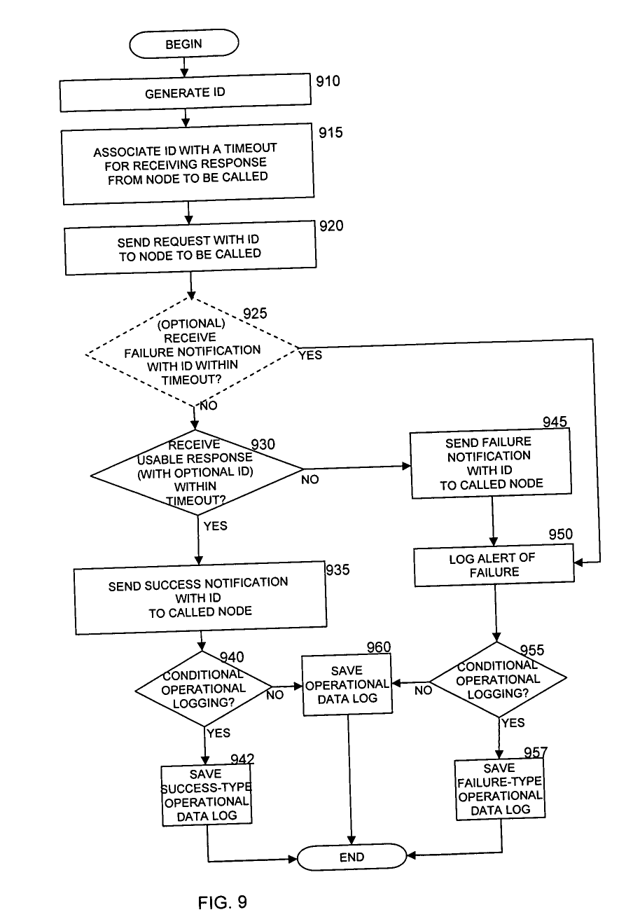

FIG. 9 illustrates one embodiment of such a method which can be performed by an initiator node of a service chain for monitoring and reporting the status of a request.

In act 910, a unique identifier may be generated that distinctively identifies the processing of a request for an online service. The unique identifier can be passed along with requests (and/or responses) from one node to another node, can be used in the reporting of failure alerts, can be used in operational data logs, and/or for any other purpose wherein the identification of a specific request to access an online service is desired. The generation of the unique identifier can be performed by a status notification facility on the initiator node, or by any other element, as the invention is not limited in this respect.

In act 915, the unique identifier can be associated with a timeout for receiving a response from a node to which a request will be sent. A timeout mechanism may be started once a request is sent by the initiator node, and allows the initiator node to deduce that a failure has occurred if an appropriate response for the request is not received before a timeout counter exceeds the timeout period. The tracking of the timeout mechanism may be directed by the status notification facility on the initiator node, by an external mechanism, or by any other element, as the invention is not limited in this respect.

In act 920, a request may be sent to a called node in the service chain. The unique identifier may be passed along with the request, thereby allowing for tracking of the request along the service chain. The request may be sent by an application program executing on the initiator node, or by any other means.

In optional act 925, the initiator node may determine whether an optional failure notification is received within the timeout period. If a failure notification is received, a determination is made as to whether the received failure notification is associated with the unique identifier for the service request sent by the initiator node (in act 920). Act 925 may be considered optional since its positive branch is followed when the called node detects a failure prior to the timeout period of the initiator node, and may not send a response to the initiator node. As such, omitting act 925 implies that the method will proceed to a timeout act 930 (discussed below) that will also initiate the acts along the positive branch of optional act 925. Hence, the result of optional act 925 may merely improve performance by minimizing the amount of time it takes to detect a failure, since the method does not have to wait for the timeout period to be exceeded before proceeding to the failure steps.

The failure notification may be a data object or structure having a failure indicator, and an accompanying data entry specifying a unique identifier. If the unique identifier of the received failure notification is the same as the unique identifier generated in act 910, then it may be deduced that the processing of the service request issued in act 920 has failed. In this case, the method proceeds to acts 950 and 955 (and hence 957 or 960), where an alert of the failure may be logged, and an operational data log may be saved.

Otherwise, the method proceeds to act 930, where a determination can be made as to whether the initiator node has received a usable response (with an optional accompanying unique identifier) within the timeout period. In some instances, a response may be received, but the response may not be usable. The response may not be usable as a result of improperly formatted data, un-executable instructions, and/or any other reason, as the invention is not limited in this respect.

In the optional approach where a unique identifier accompanies the response and the unique identifier of the received usable response is the same as the unique identifier generated in act 910, then it may be deduced that the processing of the service request issued in act 920 was successful. In another approach, the unique identifier need not be included in the response, since a request/response infrastructure may keep track of matching responses to associated requests, therefore making the unique identifier redundant. In either case, upon receiving a usable response within the timeout period, the method proceeds to act 935, where a success notification with the unique identifier may be sent to the called node in the service chain to which the request was sent in act 920.

In act 940, a determination can be made as to whether conditional logging is enabled. If conditional logging is enabled, a first type of operational data log may be saved for successful transactions (referred to as a success-type operational data log), whereas a second type of operational data log may be saved for failures (referred to as a failure-type operational data log). Furthermore, either one of the success-type and/or failure-type operational data logs may include no data, and hence operational data may not be saved in such cases, but the invention is not limited in this respect.

In one embodiment, a failure-type operational data log may include detailed operational information, whereas a success-type operational data log may include less information as compared with the failure-type operational data log. In another embodiment, operational data may only be saved upon failed transactions, and operational data for successful transaction may not be saved (i.e., the success-type operational data log may not include any information). As previously noted, these methods can minimize the operational data which is saved and may also reduce network overhead used to transmit operational data.

If conditional logging is enabled, the method can proceed to save a success-type operational data log (act 942), otherwise, the same type of operational data may be saved (act 960) irrespective of whether the transaction was determined to be a success or a failure. Upon completion of act 942 or 960, the method may then terminate. As previously described in relation to FIG. 6b, operational data from the initiator node (and also middle and end nodes) may be saved to a central data repository, and may then be processed accordingly to generate reports, such as quality of service reports and capacity planning reports.

Returning to the discussion of the decision step in act 930, when the method determines that a usable response has not been received within the timeout period, the method proceeds to act 945. In act 945, a failure notification with the unique identifier may be sent to the called node which received the request sent in act 920. The failure notification may then be used by the called node to initiate acts associated with a failure (e.g., logging an alert, saving operational data, issuing a failure notification). The method then proceeds to act 950 where an alert of the failure may be logged, and then in act 955, a determination can be made as to whether conditional operational logging is enabled.

If conditional logging is enabled, the method can proceed to save a failure-type operational data log (act 957), otherwise, the same type of operational data may be saved (act 960) irrespective of whether the transaction was determined to be a success or a failure, and then the method may terminate.

In one embodiment, a method is provided which can be performed by a middle node of a service chain for monitoring and reporting the status of a request.

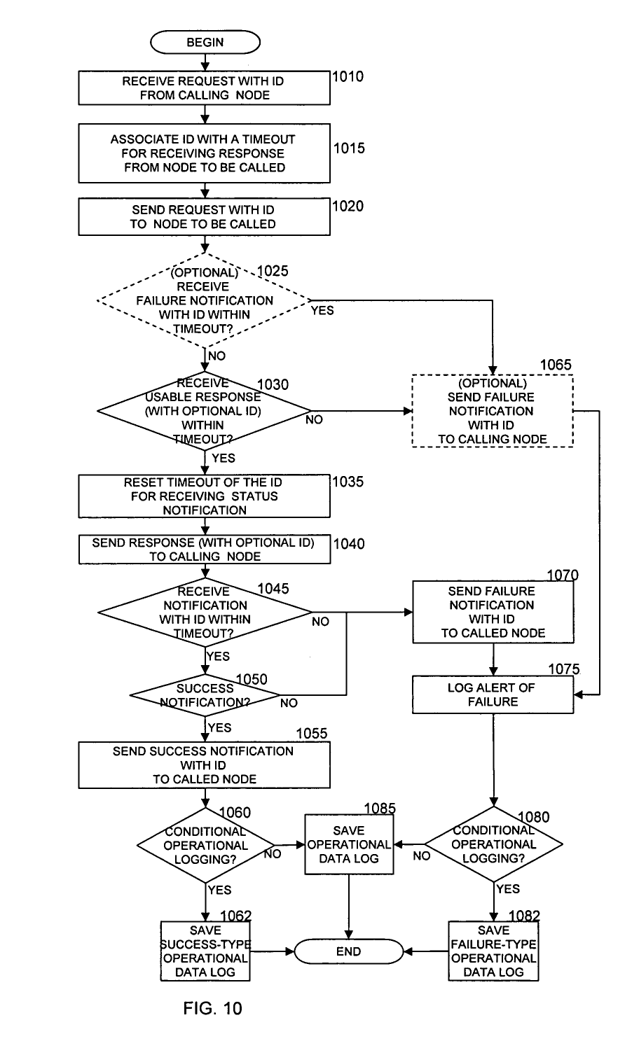

FIG. 10 illustrates one embodiment of such a method which can be performed by an middle node of a service chain for monitoring and reporting the status of a request.

In act 1010, a request may be received from a calling node. The request may be accompanied by a unique identifier that can be passed along with both requests and/or responses from one node to another node, and can be used in the reporting of failure alerts, in operational data logs, and/or for any other purpose wherein the identification of a specific request is desired.

In act 1015, the unique identifier can be associated with a timeout for receiving a response from a node to which a request will be sent. A timeout mechanism may be started once a request is sent by the current middle node executing the method of FIG. 10, and allows the current middle node to declare a failure when a usable response for the request is not received before a timeout counter exceeds the timeout period. The tracking of the timeout mechanism may be directed by a status notification facility on the current middle node, by an external mechanism, or by any other element, as the invention is not limited in his respect.

In act 1020, a request may be sent to a receiving node in the service chain. The unique identifier may be passed along with the request, thereby allowing for tracking of the request along the service chain. The request may be sent by an application executing on the middle node, or by any other means.

In optional act 1025, the current middle node may determine whether an optional failure notification is received within the timeout period. If a failure notification is received, a determination is made as to whether the received failure notification is associated with the unique identifier for the service request sent by the middle node (in act 1020). Act 1025 may be considered optional since its positive branch is followed when the called node detects a failure prior to the timeout period of the current middle node, and may not send a response to the current middle node. Therefore, omitting act 1025 implies that the method will proceed to a timeout act 1030 (discussed below) that will also initiate the acts along the positive branch of optional act 1025. Hence, the result of optional act 1025 may merely improve performance by minimizing the amount of time it takes to detect a failure, since the method does not have to wait for the timeout period to be exceeded before proceeding to the failure steps.

If the unique identifier of the received failure notification is the same as the unique identifier sent in the request in act 1020, then it may be deduced that the processing of the service request issued in act 1020 has failed. In this case, the method proceeds to act 1065 and onwards, which perform a sequence of failure related acts. In optional act 1065, a failure notification with the unique identifier may be sent back to the calling node that sent the request received in act 1010. The method can then proceed to other failure-related acts, such as logging an alert of the failure (act 1075), and saving the operational data (act 1080, and acts 1082 or 1085).

Otherwise, the method proceeds to act 1030, where a determination may be made as to whether the current middle node has received a usable response (with an optional accompanying unique identifier) within the timeout period. In some instances, a response may be received, but the response may not be usable. The response may not be usable as a result of improperly formatted data, un-executable instructions, and/or any other reason, as the invention is not limited in this respect.

In the optional approach where a unique identifier accompanies the response and the unique identifier of the received usable response is the same as the unique identifier sent in the request issued in act 1020, then it may be deduced that the processing of the service request issued in act 1020 was successful. In another approach, the unique identifier need not be included in the response, since a request/response infrastructure may keep track of matching responses to associated requests, therefore making the unique identifier redundant. In either case, upon receiving a usable response within the timeout period, the method proceeds to act 1035, otherwise the method can proceed to the previously described optional act 1065.

In act 1035, the timeout mechanism associated with the unique identifier may be reset, and may be started once a response is sent to the calling node (that sent the request which was received in act 1010). The timeout now allows the current middle node to deduce that a failure has occurred if a status notification, accompanied by the unique identifier, is not received before a timeout counter exceeds the timeout period. In act 1040, a response (along with, optionally, the unique identifier) is sent to the calling node that sent the request which was received in act 1010.

In act 1045, a determination may be made as to whether the current middle node has received a status notification with an accompanying unique identifier within the timeout period. If the accompanying unique identifier of the received status notification is the same as the unique identifier used in the previous acts, then the method proceeds to act 1050 where a determination can be made as to whether the status notification is a success notification. If a success notification was received, it may be deduced that the service request was successfully handled.

In such a case, the method proceeds to act 1055 where a success notification with the unique identifier may be sent to the node in the service chain to which the request was sent in act 1020, thereby propagating the agreement regarding the success of the service request along the nodes in the service chain established to process the service request.

Then, the method proceeds to perform act 1060 where a determination may be made as to whether conditional logging is enabled. If conditional logging is enabled, the method can proceed to save a success-type operational data log (act 1062), otherwise, the same type of operational data may be saved (act 1085) irrespective of whether the transaction was determined to be a success or a failure, and then the method can terminate.

Returning to the discussion of the negative branches of the decision steps in act 1045 and 1050, where either a status notification with the unique identifier was not received within the timeout period, or the received status notification with the unique identifier is a failure notification, the method proceeds to act 1070. In act 1070, a failure notification with the unique identifier can be sent to the called node which received the request sent in act 1020. The method then proceeds to act 1075 where an alert of the failure may be logged, and then in act 1080, a determination may be made as to whether conditional operational logging is enabled.

If conditional logging is enabled, the method can proceed to save a failure-type operational data log (act 1082), otherwise, the same type of operational data may be saved (act 1085) irrespective of whether the transaction was determined to be a success or a failure, and then the method may terminate.

In one embodiment, a method is provided which can be performed by an end node of a service chain for monitoring and reporting the status of a request.

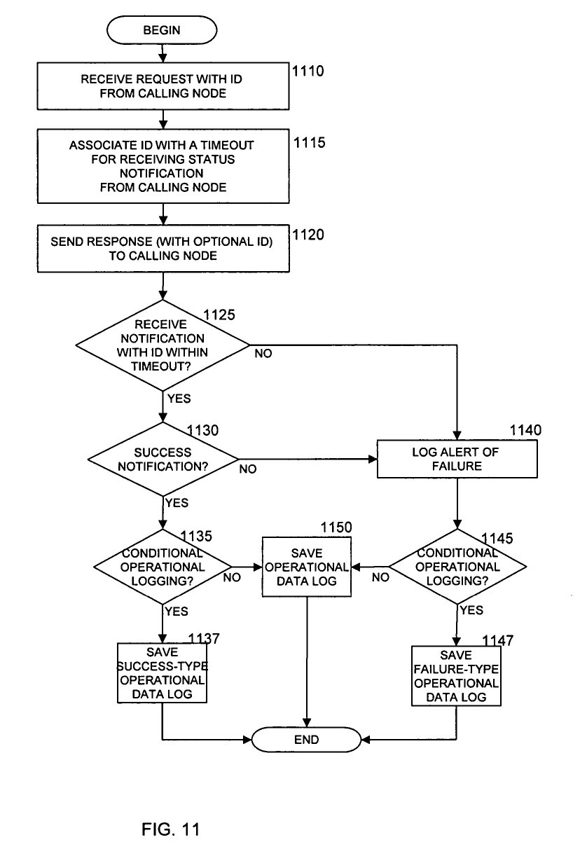

FIG. 11 illustrates one embodiment of such a method which can be performed by an end node of a service chain for monitoring and reporting the status of a request. The end node may not necessarily be the last node in the service chain, but may be the last node, in a service chain, having a status notification facility.

In act 1110, a request may be received from a calling node. The request may be accompanied by a unique identifier that can be passed along with both requests and/or responses from one node to another node.

In act 1115, the unique identifier can be associated with a timeout for receiving a status notification from the calling node. A timeout mechanism may be started once a request is sent by the end node executing the method of FIG. 11, and allows the end node to declare a failure if an appropriate status notification is not received before a timeout counter exceeds the timeout period. The tracking of the timeout mechanism may be directed by a status notification facility on the end node, by an external mechanism, or by any other element, as the invention is not limited in this respect.

In act 1120, a response (along with, optionally, the unique identifier) can be sent back to the calling node (that sent the request received in act 1110).

In act 1125, a determination may be made as to whether the end node has received a status notification with an accompanying unique identifier within the timeout period. If the accompanying unique identifier of a received status notification is the same as the unique identifier used in the previous acts, then the method proceeds to act 1030 where a determination is made as to whether the status notification is a success notification. If a success notification was received, it may be deduced that the service request was successfully handled.

In such a case, the method proceeds to act 1135 where a determination may be made as to whether conditional logging is enabled. If conditional logging is enabled, the method can proceed to save a success-type operational data log (act 1137), otherwise, the same type of operational data may be saved (act 1150) irrespective of whether the transaction was determined to be a success or a failure, and then the method can terminate.

Returning to the discussion of the negative branches of the decision steps in act 1125 and 1130 (where either a status notification with the unique identifier has not been received within the timeout period, or the received status notification with the unique identifier is a failure notification), in either case, the method proceeds to act 1140 where an alert of the failure may be logged. Then in act 1145, a determination can be made as to whether conditional operational logging is enabled.

If conditional logging is enabled, the method can proceed to save a failure-type operational data log (act 1147), otherwise, the same type of operational data may be saved (act 1150) irrespective of whether the transaction was determined to be a success or a failure, and then the method can terminate.

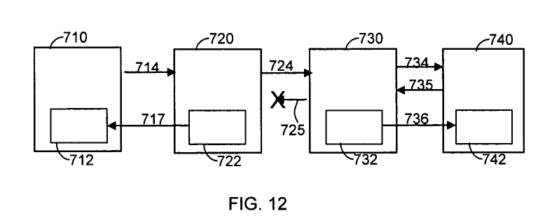

FIG. 12 illustrates one example of failure that may occur in a service chain processing a request for a service. In this example, connectivity is lost during the sending of response 725, and hence node 720 is the first node to timeout due to the inability of response 725 to reach node 720. Since node 720 timeouts, the status notification facility 722 logs a failure event and saves operational data. The status notification facility 722 on node 720 may also optionally propagate a failure notification 717 back to node 710.

Node 730 may then timeout due to a lack of status notification, and hence the status notification facility 732 logs a failure event and saves operational data. The status notification facility 732 on node 730 may also optionally propagate a failure notification 736 forward to node 742. In this way, a loss of connectivity between two nodes in a service chain propagates a failure notification in both directions away from the broken link and along the entire service chain, thereby attempting to ensure that all nodes in the service chain agree regarding the failure of the service request.

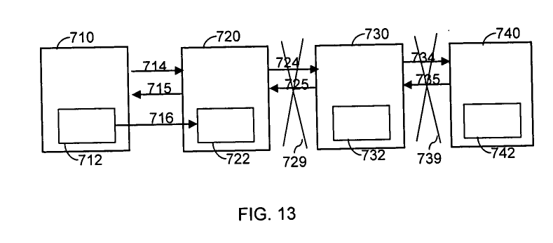

FIG. 13 illustrates another example of failure that may occur in a service chain processing a request for a service. In this example, transient connectivity problems (indicated by 729 and 739) are experienced at two communication links in the service chain. In this example, node 710 receives a response 715 and issues a success notification 716 to node 720. Simultaneously, nodes 730 and 740 experience connectively problems 729 and 739, and therefore are unable to receive a success notification (not shown) issued by node 720. Therefore, nodes 730 and 740 both timeout and log failure events and save operational data. These events are false positives due to transient connectivity problems which did not impede the successful completion of the service requested by node 710. As such, these false positives may be identified during post-processing of the logged failure events and/or operational data.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code. In this respect, it should be appreciated that one embodiment of the invention is directed to a computer-readable medium or multiple computer-readable media (e.g., a computer memory, one or more floppy disks, compact disks, optical disks, magnetic tapes, etc.) encoded with one or more programs that, when executed, on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that, when executed, perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing, and the aspects of the present invention described herein are not limited in their application to the details and arrangements of components set forth in the foregoing description or illustrated in the drawings. The aspects of the invention are capable of other embodiments and of being practiced or of being carried out in various ways. Various aspects of the present invention may be implemented in connection with any type of network, cluster or configuration. No limitations are placed on the network implementation.

Accordingly, the foregoing description and drawings are by way of example only.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalent thereof as well as additional items.

What is claimed:

1. A method of operating a computer system comprising computer nodes, the method comprising acts of:
(A) upon receiving a request for a service, creating a service chain for processing the request for the service, wherein the service chain comprises a first plurality of the computer nodes, and wherein the first plurality of the computer nodes is unknown prior to receiving the request for the service; and
(B) guaranteeing agreement, on at least two computer nodes of the first plurality of the computer nodes, about a status of the processing of the request for the service.

2. The method of claim 1, wherein the status of the processing of the request comprises an indication of a success in the processing of the request for the service.

3. The method of claim 1, wherein the status of the processing of the request comprises an indication of a failure in the processing of the request for the service.

4. The method of claim 3, further comprising an act of reporting the failure in the processing of the request for the service.

5. The method of claim 4, wherein the act of reporting the failure in the processing of the request for the service comprises reporting the failure in the processing of the request for the service to a service operations center.

6. The method of claim 3, further comprising an act of saving operational data at least partially in response to the failure in the processing of the request for the service.

7. The method of claim 6, wherein the act of saving operational data comprises providing the operational data to a centralized data repository.

8. The method of claim 7, wherein the operational data comprises performance data at least partially related to the processing of the request for the service.

9. The method of claim 1, wherein the act (B) comprises guaranteeing agreement, on each of the computer nodes of the first plurality of computer nodes, about the status of the processing of the request for the service.

10. The method of claim 1, wherein the act (A) comprises directing the request for the service using at least one network load balancer.

11. A method of operating a computer system comprising computer nodes, the method comprising acts of:
(A) upon receiving a request for a service, creating a service chain for processing the request for the service, wherein the service chain comprises a first plurality of the computer nodes, and wherein the first plurality of the computer nodes is unknown prior to receiving the request for the service; and
(B) saving operational data at least partially in response to a failure in the processing of the request for the service.

12. The method of claim 11, wherein the operational data comprises performance data at least partially related to the processing of the request for the service.

13. The method of claim 11, wherein the act (B) comprises providing the operational data to a centralized data repository.

14. The method of claim 13, further comprising an act of extracting data from the centralized data repository at least partially in response to a query.

15. The method of claim 11, wherein the act (B) comprises saving first operational data associated with a first computer node in the service chain, and saving second operational data associated with a second computer node in the service chain.

16. At least one computer readable medium encoded with a plurality of instructions that, when executed, performs a method of operating a computer system comprising computer nodes, the method comprising acts of:
(A) upon receiving a request for a service, creating a service chain for processing the request for the service, wherein the service chain comprises a first plurality of the computer nodes, and wherein the first plurality of the computer nodes is unknown prior to receiving the request for the service;
(B) guaranteeing agreement, on at least two computer nodes of the first plurality of the computer nodes, about a failure in the processing of the request for the service; and
(C) saving operational data at least partially in response to the failure in the processing of the request for the service.

17. The at least one computer readable medium of claim 16, wherein the method further comprises an act of reporting the failure in the processing of the request for the service.

18. The at least one computer readable medium of claim 16, further comprising an act of determining an occurrence of the failure in the processing of the request for the service at least partially based on exceeding a timeout for receiving a response to the request for the service.

19. The at least one computer readable medium of claim 18, further comprising an act of associating a unique identifier with the request for the service.

20. The at least one computer readable medium of claim 19, wherein the act (B) comprises sending a notification of the failure in the processing of the request for the service from a first computer node in the service chain to a second computer node in the service chain, and wherein the notification comprises the unique identifier.
